(19) United States
(12) Patent Application Publication
(10) Pub. No.: US 2024/0410778 A1
(43) Pub. Date: Dec. 12, 2024

(54) APPARATUS, SYSTEM AND METHOD FOR USE IN GAS EMISSION DETECTION AND/OR QUANTIFICATION

(71) Applicant: IKM Testing UK Limited, Aberdeenshire (GB)

(72) Inventors: Mark RASMUSEN, Aberdeenshire (GB); Sam ROWLEY, Aberdeenshire (GB); Scott MORTON, Aberdeenshire (GB)

(73) Assignee: IKM Testing UK Limited, Aberdeenshire (GB)

(21) Appl. No.: 18/697,076

(22) PCT Filed: Sep. 30, 2022
(86) PCT No.: PCT/GB2022/052481

§ 371 Date: Mar. 29, 2024

(30) Foreign Application Priority Data
Oct. 1, 2021 (GB) 2114140.3

(51) Int. Cl. G01M 3/22; F16L 23/00; F17D 5/02

(52) U.S. Cl. CPC G01M 3/223; F16L 23/006; F17D 5/02; F16L 2201/30

(57) ABSTRACT

An apparatus (10;210;310) for use in a system (1000;2000) for detecting and/or quantifying gas emissions from a pipe connection (C) comprises a body (12;212;312) configured for location on and around the pipe connection (C). The body (12;212;312) is configured to form an enclosure around the pipe connection (C) when located thereon so as to define an enclosed void (V;V′) between the body (12;212;312) and the pipe connection (C). The apparatus (10;210;310) comprises an inlet arrangement (14;214;314) and an outlet arrangement (16;216;316). The inlet arrangement (14;214;314) is configured to facilitate ingress of a test fluid into the enclosed void (V;V′) and the outlet arrangement (16;216;316) is configured to facilitate exhaust of the test fluid together with air and/or any gas emitted from the pipe connection (C) from the enclosed void (V;V′), so as to permit detection and/or quantification of gas emissions from the pipe connection (C) to be determined.

### FIELD

This relates to an apparatus, system and method for use in gas emission detection and/or quantification. More particularly, this relates to an apparatus for use in a system for detecting and/or quantifying gas emissions from a pipe connection, a system comprising the apparatus, and to a method of detecting and/or quantifying gas emissions from a pipe connection.

### BACKGROUND

Pipelines are used in a wide variety of applications in order to transport fluids and other transportable media over distance, one of the most significant of these being the transportation of gas products such as natural gas, methane, ethane, helium, hydrogen, and carbon dioxide.

Gas products form a critical part of the industrial infrastructure.

Given the importance and safety critical nature of many gas pipelines, gas pipelines are typically subject to regular inspection and maintenance regimes.

Amongst other things, this requires the ability to accurately detect and/or quantify gas emissions.

However, the detection and/or quantification of gas emissions poses a number of significant challenges.

### SUMMARY

Aspects of the present disclosure relate to an apparatus, system and method for use in gas emission detection and/or quantification. More particularly, this relates to an apparatus for use in a system for detecting and/or quantifying gas emissions from a pipe connection, a system comprising the apparatus, and to a method of detecting and/or quantifying gas emissions from a pipe connection.

According to a first aspect, there is provided an apparatus for use in a system for detecting and/or quantifying gas emissions from a pipe connection, the apparatus comprising:
a body configured or configurable for location on and around the pipe connection,
wherein the body is configured to form an enclosure around a portion of the pipe connection when located thereon so as to define an enclosed void between the body and the portion of the pipe connection;
an inlet arrangement configured to facilitate ingress of a test fluid into the enclosed void; and
an outlet arrangement configured to facilitate exhaust of the test fluid together with air and/or any gas emitted from the pipe connection from the enclosed void.

In use, the apparatus is located on the pipe connection to be tested, the body being configured to form the enclosure around the portion of the pipe connection and thereby define the enclosed void between the body and the portion of the pipe connection. The test fluid, which may comprise or take the form of a reference fluid, in particular a reference gas, and which has a known composition of the gas being detected and/or quantified, is then flowed into the enclosed void through the inlet arrangement, where it co-mingles with the air and any gas emitted from the pipe connection already present in the enclosed void. The co-mingled product flows out through the outlet arrangement. In particular embodiments, the test fluid is flowed in and resulting co-mingled product flowed out of the enclosed void (i.e. flushed through) until the gas composition reading, e.g. methane and/or ethane concentration, in the enclosed void has stabilised. Once the gas composition reading has stabilised, the apparatus may be configured and/or operable to determine one or more quantitative measurements in the enclosed void, thereby providing the data required to calculate the rate of emission of the gas from the pipe connection. Alternatively, the test fluid may be flowed in and resulting co-mingled product flowed out of the enclosed void (i.e. flushed through) until the gas composition reading, e.g. methane and/or ethane concentration, in the enclosed void is the same, substantially the same or similar to that of the test fluid. This sets a base line for subsequent quantitative measurement(s). Once the base line has been established, the apparatus is operable to determine one or more quantitative measurements in the enclosed void.

The apparatus may be used to detect and/or quantify a wide range of gasses including but not limited to one or more of natural gas, methane, ethane, helium, hydrogen, and carbon dioxide.

Beneficially, the apparatus facilitates a more accurate detection and/or quantification of gas emissions from a pipe connection than conventional systems and techniques. By providing an enclosed void, the apparatus creates a controlled or more controlled environment that eliminates or at least mitigates against the effects of weather or other environmental conditions that may otherwise inhibit an accurate assessment of the pipe connection being tested.

Moreover, by virtue of the test fluid being flowed into and resulting co-mingled product flowed out of the enclosed void (i.e. flushed through) via the inlet arrangement and outlet arrangement, the apparatus creates a highly controlled environment from which extremely accurate quantitative measurements in the enclosed void can be obtained.

Moreover, the provision of an enclosed void eliminates or at least mitigates against the effects of emissions from another source, such as another pipe connection or a leak in the pipeline, contaminating the test result.

Moreover, the apparatus is re-usable, lightweight, temporary and/or is quick and easy to install, operate and remove, facilitating a more efficient inspection regime. For example, the apparatus may be configured and/or operable to rapidly facilitate the quantification of leak rates from one or more pipe connections, and with a minimum or at least reduced waste.

Moreover, the apparatus may be configured and/or operable for use on a pipe connection forming part of an operational pipeline, i.e. at pressure and carrying gas.

The apparatus may be used or configured for use with a variety of different forms of pipe connection, e.g. having different pipe diameters and/or pressure classes.

For example, the pipe connection may comprise or take the form of a flange connection. The flange connection may comprise or take the form of a flange connection between two sections of pipe. Alternatively, the flange connection may comprise or take the form of blind flange connection.

Alternatively, the pipe connection may comprise or take the form of a bolted pipe connection, a welded pipe connection, a threaded pipe connection, a grooved pipe connection or other form of pipe connection.

As described above, the apparatus comprises a body configured or configurable for location on and around the pipe connection, the body configured to form an enclosure around a portion of the pipe connection when located thereon, so as to define an enclosed volume between the body and the portion of the pipe connection.

The body may be configured or configurable for location on and around a circumferential surface portion of the pipe connection.

The body may be configured to engage the pipe connection or portion of the pipe connection, in particular the outer circumferential surface portion of the pipe connection, so as to define a sealed or substantially sealed enclosure. The body may be configured to sealingly engage the pipe connection or part of the pipe connection, in particular the circumferential surface portion of the pipe connection.

The body may be configured to form the enclosure around an interface between components of the pipe connection and/or around a void between the mating surfaces of the pipe connection.

The interface may be between the mating surfaces of the pipe connection.

Where the pipe connection comprises or takes the form of a flange connection, the body may be configured to form the enclosure around the interface between the mating surfaces of the flanges of the flange connection, the void between the mating surfaces of the flanges and/or around a seal arrangement, e.g. gasket seal, disposed between the mating surfaces of the flanges.

Where the pipe connection comprises or takes the form of a bolted pipe connection, the body may be configured to form the enclosure around the interface between the mating surfaces of the bolted connection, the void between the mating surfaces of the bolted connection and/or around a seal arrangement, e.g. gasket seal, disposed between the mating surfaces of the bolted connection.

Where the pipe connection comprises or takes the form of a welded pipe connection, the body may be configured to form the enclosure around the interface between the mating surfaces of the welded connection, the void between the mating surfaces of the bolted connection and/or around the weld.

Where the pipe connection comprises or takes the form of a threaded pipe connection, the body may be configured to form the enclosure around the interface between the mating surfaces of the threaded connection and/or the void between the mating surfaces of the threaded connection.

Where the pipe connection comprises or takes the form of a grooved pipe connection, the body may be configured to form the enclosure around the interface between the mating surfaces of the grooved connection and/or the void between the mating surfaces of the threaded connection.

As described above, the body is configured or configurable for location on and around the pipe connection.

The body may comprise or take the form of a cuff, a wrap or band.

The body may be configurable in a first configuration.

The body may be planar or substantially planar in the first configuration. Alternatively, the body may be annular or part-annular in the first configuration.

The body may be configurable in or reconfigurable into a second configuration. The body may be reconfigurable between the first configuration and the second configuration, and/or vice-versa.

The body may be annular in the second configuration.

In particular embodiments, the apparatus may be located on the pipe connection in the first configuration and then reconfigured to the second configuration, the body in the second configuration forming the enclosed void.

For example, in the first configuration the body may be planar, substantially planer or part-annular and the body may then be reconfigured to be annular in the second configuration to form the enclosed void.

Alternatively, the body may be annular in both the first configuration and the second configuration. The inner diameter of the body in the second configuration may be different, e.g. smaller or larger, than the inner diameter of the body in the first configuration or may be the same diameter. The body may be locatable on the pipe connection in the first configuration and then reconfigured to the second configuration to form the enclosed void. The body may be elastically deformable to permit reconfiguration of the body between the first configuration and the second configuration.

In other embodiments, the apparatus may be located on the pipe connection in the first configuration, the body in the first configuration forming the enclosed void. For example, the body may be configured, e.g. sized and/or annularly shaped, so that when located on the pipe connection the body forms the enclosed void.

The body may be at least partially constructed from a material which prevents, substantially prevents or restricts passage of air and/or the gas to be detected. In some instances, the body may be pressure-retaining. Alternatively, the body may not be pressure-retaining. The at least part of the body constructed from the material which prevents, substantially prevents or restricts passage of air and/or the gas to be detected forms the enclosed void.

The body may be at least partially constructed from a polymeric material.

The body may be at least partially constructed from an elastomeric material. The body may be at least partially constructed from a synthetic rubber material. The body may be at least partially constructed from Polychloroprene e.g. Neoprene. The Neoprene material may for example comprise or take the form of W8 grade Neoprene.

The body may be at least partially constructed from a closed cell material. The body may be at least partially constructed from a closed cell elastomeric material. The body may be at least partially constructed from a closed cell synthetic rubber material. The body may be at least partially constructed from a closed cell Polychloroprene, e.g. Neoprene, material. The Neoprene material may for example comprise or take the form of W8 grade Neoprene.

The body may be at least partially constructed from a lined elastomeric material. The body may be at least partially constructed from a lined synthetic rubber material. The body may be at least partially constructed from a lined Polychloroprene, e.g. Neoprene, material. The Neoprene material may for example comprise or take the form of W8 grade Neoprene.

The body may be at least partially constructed from a single-lined elastomeric material, i.e. the body may be lined on one surface. The body may be at least partially constructed from a single-lined synthetic rubber material. The body at least partially may be constructed from a single-lined Polychloroprene, e.g. Neoprene, material. The Neoprene material may for example comprise or take the form of W8 grade Neoprene.

The body may be lined with a polymeric material. The body may be lined with a polymeric fabric material. The body may be lined with Nylon fabric material.

In use, the body may be disposed on and around the pipe connection so that the un-lined surface of the body faces the pipe connection.

Alternatively, the body may be at least partially constructed from an unlined material.

In particular embodiments, the body may be constructed from a single Nylon lined closed cell Neoprene material.

Alternatively, the body may be constructed from a fabric material.

As described above, the apparatus comprises an inlet arrangement configured to facilitate ingress of the test fluid into the enclosed void.

The inlet arrangement may comprise or take the form of an inlet valve. The inlet valve may be configured and/or oriented to permit ingress of the test fluid into the enclosed void and restrict or prevent exhaust of the test fluid through the inlet valve.

The inlet valve may comprise or take the form of a selectively openable valve. The inlet valve may comprise or take the form of a non-return valve. The inlet valve may comprise or take the form of a Schrader valve.

The inlet arrangement may comprise or take the form of a coupling adapter.

The coupler may comprise or take the form of a Schrader coupling adapter.

The inlet arrangement may comprise or take the form of a coupler. The coupler may comprise or take the form of a Schrader coupler.

As described above, the apparatus comprises an outlet arrangement configured to facilitate exhaust of the co-mingled product, i.e., the test fluid together with air and/or any gas emitted from the pipe connection from the enclosed void.

The outlet arrangement may comprise or take the form of an outlet valve. The outlet valve may be configured and/or oriented to permit exhaust of the co-mingled product, i.e. the test fluid together with air and/or any gas emitted from the pipe connection and restrict fluid passage into the enclosed void. The outlet valve may comprise or take the form of a selectively openable valve. The outlet valve may comprise or take the form of a non-return valve. The outlet valve may comprise or take the form of a Schrader valve.

The outlet arrangement may comprise or take the form of a coupling adapter. The coupler may comprise or take the form of a Schrader coupling adapter.

The outlet arrangement may comprise or take the form of a coupler. The coupler may comprise or take the form of a Schrader coupler.

The inlet arrangement and the outlet arrangement may be spaced on the body. The inlet arrangement and the outlet arrangement may be spaced on the body so that when the body is disposed on the pipe connection the inlet arrangement and the outlet arrangement define a separation angle. For example, but not exclusively, the separation angle may be in the range of 120 degrees to 180 degrees.

Beneficially, the ability to adapt the separation angle permits the configuration of the apparatus to be adapted, e.g. adapted to the configuration of the pipe connection. For example, in some instances the pipe connection may not permit a 180 degree separation angle. As such, the apparatus provides for a range of separation angles.

In use, the inlet arrangement and the outlet arrangement may be interchangeable, i.e. the inlet arrangement may alternatively be used as the outlet arrangement and the outlet arrangement may alternatively be used as the inlet arrangement.

Alternatively or additionally, the separation angle between the inlet arrangement and the outlet arrangement may be adjusted manually when the body is reconfigured from the first configuration to the second configuration.

The apparatus may comprise a securement arrangement.

The securement arrangement may comprise or take the form of a releasable securement arrangement.

The securement arrangement may be configured to retain the body on the pipe connection.

The securement arrangement may be configured to secure a first portion, e.g. first end portion, of the body to a second portion, e.g. second end portion, of the body.

The securement arrangement may comprise or take the form of hook and loop fastener arrangement, e.g. a Velcro fastener arrangement. A hook side of the hook and loop fastener arrangement may be disposed on the first portion, e.g. first end portion of the body. A loop side of the hook and loop fastener arrangement may be disposed on the second portion, e.g. second end portion.

The apparatus may comprise a strap arrangement.

In use, the strap arrangement may facilitate handling of the body and/or to facilitate release of the securement arrangement.

The strap arrangement may comprise one or more straps.

The apparatus may comprise, may be coupled to or operatively associated with a pressurised test fluid supply.

The pressurised test fluid supply may be configured to supply the test fluid to the enclosed void via the inlet arrangement.

The pressurised test fluid supply may comprise a compressed fluid cylinder.

The pressurised test fluid supply may comprise a compressed gas cylinder. The pressurised test fluid supply may comprise a compressed air cylinder. The pressurised test fluid supply may comprise a compressed air cylinder having ambient air of known composition, in particular a known composition of the gas being detected and/or quantified.

The pressurised test fluid supply may comprise a pressure regulator. The pressure regulator may comprise or take the form of two-stage regulator.

The pressurised test fluid supply may be directly coupled to the body.

The apparatus may comprise a fluid communication arrangement for supplying the test fluid to the inlet arrangement. The fluid communication arrangement may comprise a fluid line, for example a hose.

The fluid communication arrangement may comprise a coupler for connecting the fluid line, for example hose, to the inlet arrangement. The connector may comprise or take the form of a clip-on connector, Schrader coupler or other suitable coupler.

According to a second aspect, there is provided a system for detecting and/or quantifying gas emissions from a pipe connection, the system comprising:
the apparatus of the first aspect; and
a gas analyser.

The apparatus may comprise, may be coupled to or operatively associated with the gas analyser.

The gas analyser may comprise or take the form of a portable gas analyser.

The apparatus may be directly coupled to the gas analyser.

The system may comprise a fluid communication arrangement for coupling the apparatus to the gas analyser. The fluid communication arrangement may comprise a fluid line, for example a hose.

The fluid communication arrangement for coupling the apparatus to the gas analyser may comprise a coupling for connecting the fluid line, for example hose, to the outlet arrangement. The coupling may comprise or take the form of a clip-on connector, Schrader coupler or other suitable coupling.

The system may be configured to display the quantitative measurement(s), e.g. to an operator or user. For example, the system may be configured to display the quantitative base line measurement and/or subsequent quantitative measurement(s), e.g. to an operator or user. For example, the system may comprise a visual display unit.

Alternatively or additionally, the system may comprise a communication arrangement configured to communicate the quantitative base line measurement and/or subsequent quantitative measurement(s) and/or other data, e.g. location data, pipe connector identification data, to one or more remote location.

The remote location may comprise or take the form of a mobile device such as tablet, mobile phone or the like. Alternatively or additionally, the remote location may comprise or take the form of a control room.

Alternatively or additionally, the remote location may comprise or take the form of a data store, such as an online data store.

The communication arrangement may comprise or take the form of a wireless communication arrangement. The wireless communication arrangement may comprise a radio frequency communication arrangement.

The communication arrangement may comprise or take the form of a transmitter or transceiver.

The communication arrangement may comprise or take the form of a wired communication arrangement. The wired communication arrangement may comprise or take the form of an electric wire and/or optical fibre communication arrangement.

Alternatively or additionally, the system may comprise, may be coupled to or operatively associated with a processing system.

The processing system, or part of the processing system, may be configured or operable to control the apparatus and/or the system.

The processing system, or part of the processing system, may form part of the system.

The processing system, or part of the processing system, may be coupled to or operatively associated with the system. For example, the processing system may be located at one or more remote location. The remote location may comprise or take the form of a mobile device such as tablet, mobile phone or the like. Alternatively or additionally, the remote location may comprise or take the form of a control room. Alternatively or additionally, the remote location may comprise or take the form of a data store, such as an online data store.

The system may be configured to transmit information from the processing system to the apparatus and/or system. The communication arrangement may comprise or take the form of a two-way communication arrangement. The communication arrangement may comprise or take the form of a transceiver.

According to a third aspect, there is provided a method of detecting and/or quantifying gas emissions from a pipe connection, using the apparatus of the first aspect or the system of the second aspect.

In use, the apparatus is located on the pipe connection to be tested, the body being configured to form the enclosure around the portion of the pipe connection and thereby define the enclosed void between the body and the portion of the pipe connection. The test fluid, which may comprise or take the form of a reference fluid, in particular a reference gas, and which has a known composition of the gas being detected and/or quantified, is then flowed into the enclosed void through the inlet arrangement, where it co-mingles with the air and any gas emitted from the pipe connection already present in the enclosed void. The co-mingled product flows out through the outlet arrangement. In particular embodiments, the test fluid is flowed in and resulting co-mingled product flowed out of the enclosed void (i.e. flushed through) until the gas composition reading, e.g. methane and/or ethane concentration, in the enclosed void has stabilised. Once the gas composition reading has stabilised, the apparatus may be configured and/or operable to determine one or more quantitative measurements in the enclosed void, thereby providing the data required to calculate the rate of emission of the gas from the pipe connection. Alternatively, the test fluid may be flowed in and resulting co-mingled product flowed out of the enclosed void (i.e. flushed through) until the gas composition reading, e.g. methane and/or ethane concentration, in the enclosed void is the same, substantially the same or similar to that of the test fluid. This sets a base line for subsequent quantitative measurement(s). Once the base line has been established, the apparatus is operable to determine one or more quantitative measurements in the enclosed void.

The method may comprise carrying out one or more quantitative measurements in the enclosed void using the gas analyser.

In particular embodiments, the method comprises carrying out a plurality of quantitative measurements in the enclosed void using the gas analyser. Beneficially, this permits the system to obtain a significant number of quantitative measurements, e.g. 1000's of measurements, in order to rapidly and/or efficiently quantify the rate of gas emission from the pipe connection. For example, but not exclusively, the gas analyser may be configured and/or operable to operate at a frequency of 5 Hz or about 5 Hz.

The method may be used to detect and/or quantify a wide range of gasses including but not limited to natural gas, methane, ethane, helium, hydrogen, and carbon dioxide.

Beneficially, the method facilitates a more accurate detection and/or quantification of gas emissions from a pipe connection than conventional systems and techniques. By providing an enclosed void, the apparatus creates a controlled or more controlled environment that eliminates or at least mitigates against the effects of weather or other environmental conditions that may otherwise inhibit an accurate assessment of the pipe connection being tested.

Moreover, by virtue of the test fluid being flowed into and resulting co-mingled product flowed out of the enclosed void (i.e. flushed through) via the inlet arrangement and outlet arrangement, the apparatus creates a highly controlled environment from which extremely accurate quantitative measurements in the enclosed void can be obtained.

Moreover, the provision of an enclosed void eliminates or at least mitigates against the effects of emissions from another source, such as another pipe connection or a leak in the pipeline, contaminating the test result.

The invention is defined by the appended claims. However, for the purposes of the present disclosure it will be understood that any of the features defined above or described below may be utilised in isolation or in combination. For example, features described above in relation to one of the above aspects or below in relation to the detailed description may be utilised in any other aspect, or together form a new aspect.

### BRIEF DESCRIPTION OF THE DRAWINGS

These and other aspects will now be described, by way of example only, with reference to the accompanying drawings, in which:

FIG. 1 shows a perspective view of an apparatus for use in a system for detecting and/or quantifying gas emissions from a pipe connection;

FIG. 2 shows a cross-sectional view of the apparatus shown in FIG. 1;

FIG. 3 shows a side view of the apparatus shown in FIG. 1;

FIG. 4 shows a top view of the body of the apparatus shown in FIG. 1;

FIG. 5 shows a side view of the body of the apparatus shown in FIG. 1;

FIG. 6 shows a bottom view of the body of the apparatus shown in FIG. 1;

FIGS. 7, 8 and 9 show an inlet arrangement of the apparatus shown in FIG. 1;

FIGS. 10, 11 and 12 show an outlet arrangement of the apparatus shown in FIG. 1;

FIGS. 13 and 14 show a system for detecting and/or quantifying gas emissions from a pipe connection;

FIG. 15 shows a user interface of the system shown in FIGS. 13 and 14;

FIG. 16 shows an alternative apparatus for use in a system for detecting and/or quantifying gas emissions from a pipe connection, having an alternative inlet arrangement position to that of the apparatus shown in FIG. 1;

FIGS. 17 and 18 show an alternative inlet arrangement;

FIGS. 19 and 20 show an alternative outlet arrangement;

FIGS. 21, 22 and 23 show a further alternative apparatus for use in a system for detecting and/or quantifying gas emissions from a pipe connection; and

FIG. 24 shows an alternative system for detecting and/or quantifying gas emissions from a pipe connection to that shown in FIGS. 13 and 14.

### DETAILED DESCRIPTION OF THE DRAWINGS

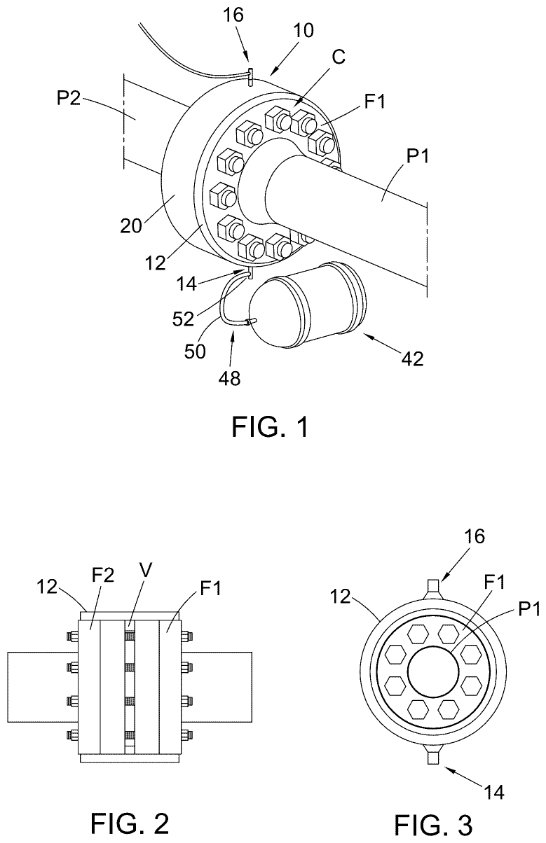

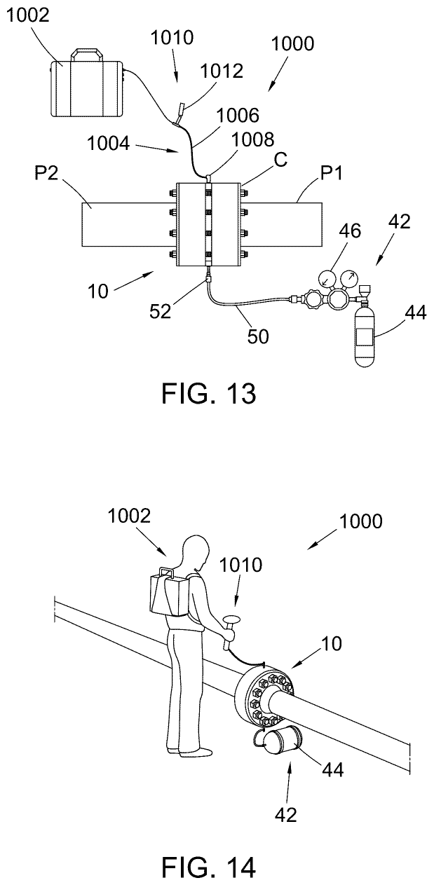

Referring first to FIGS. 1, 2 and 3 of the accompanying drawings, there is shown an apparatus 10 for use in a system (1000, FIG. 13; 2000; FIG. 24) for detecting and/or quantifying gas emissions from a pipe connection C.

As shown, the apparatus 10 comprises a body 12 configured for location on and around the circumferential surface of the pipe connection C, which as shown takes the form of a flange connection between a first pipe section P1 and a second pipe section P2 and having flanges F1, F2.

The body 12 is configured to form an enclosure around a portion of the pipe connection C when located thereon, so as to define an enclosed void V between the body 12 and the outer circumferential surface of the pipe connection C.

The apparatus 10 further comprises an inlet arrangement, generally denoted 14, and an outlet arrangement, generally denoted 16. The inlet arrangement 14 is configured to facilitate ingress of a test fluid into the enclosed void V. The outlet arrangement 16 is configured to facilitate exhaust of the test fluid together with air and/or any gas emitted from the pipe connection C from the enclosed void V.

In use, the apparatus 10 is located on the pipe connection C to be tested, the body 12 being configured to form the enclosure around the portion of the pipe connection C and thereby define the enclosed void V between the body 12 and the portion of the pipe connection C. The test fluid, which may comprise or take the form of a reference fluid, in particular a reference gas, and which has a known composition of the gas being detected and/or quantified, is then flowed into the enclosed void V through the inlet arrangement 14, where it co-mingles with the air and any gas emitted from the pipe connection C already present in the enclosed void V. The co-mingled product flows out through the outlet arrangement 16. In particular embodiments, the test fluid is flowed in and resulting co-mingled product flowed out of the enclosed void (i.e. flushed through) until the gas composition reading, e.g. methane and/or ethane concentration, in the enclosed void has stabilised, thereby providing the data required to calculated the rate of emission of the gas from the pipe connection. Once the gas composition reading has stabilised, the apparatus may be configured and/or operable to determine one or more quantitative measurements in the enclosed void, thereby providing the data required to calculate the rate of emission of the gas from the pipe connection. Alternatively, the test fluid is flowed in and resulting co-mingled product flowed out of the enclosed void V (i.e. flushed through) until the gas composition reading, e.g. methane and/or ethane concentration, in the enclosed void V is the same, substantially the same or similar to that of the test fluid. This sets a base line, e.g. quantitative base line, for subsequent quantitative measurement(s). Once the base line has been established, the apparatus 10 is operable to determine one or more quantitative measurements in the enclosed void V.

Beneficially, the apparatus 10 facilitates a more accurate detection and/or quantification of gas emissions from a pipe connection C than conventional systems and techniques. By providing an enclosed void V, the apparatus 10 creates a controlled or more controlled environment that eliminates or at least mitigates against the effects of weather or other environmental conditions that may otherwise inhibit an accurate assessment of the pipe connection C being tested.

Moreover, by virtue of the test fluid being flowed into and resulting co-mingled product flowed out of the enclosed void V (i.e. flushed through) via the inlet arrangement 14 and outlet arrangement 16, the apparatus 10 creates a highly controlled environment from which extremely accurate quantitative measurements in the enclosed void V can be obtained.

Moreover, the provision of an enclosed void V eliminates or at least mitigates against the effects of emissions from another source, such as another pipe connection or a leak in the pipeline, contaminating the test result.

Moreover, the apparatus 10 is re-usable, lightweight, temporary/or and is quick and easy to install, operate and remove, facilitating a more efficient inspection regime. For example, the apparatus may be configured and/or operable to rapidly facilitate the quantification of leak rates from one or more pipe connections, and with a minimum or at least reduced waste.

The apparatus 10 may be used or configured for use with a variety of different forms of pipe connection, e.g. having different pipe diameters and/or pressure classes.

In the illustrated apparatus 10, the body 12 takes the form of a cuff, wrap or band and is reconfigurable between a first configuration and a second configuration, the body 12 in the second configuration defining the enclosure around the pipe connection C. The body 12 is reconfigurable between the first configuration and the second configuration, and vice-versa. Beneficially, this means that the apparatus 10 is re-usable, and is quick and easy to install and operate, facilitating a more efficient inspection regime to be carried out.

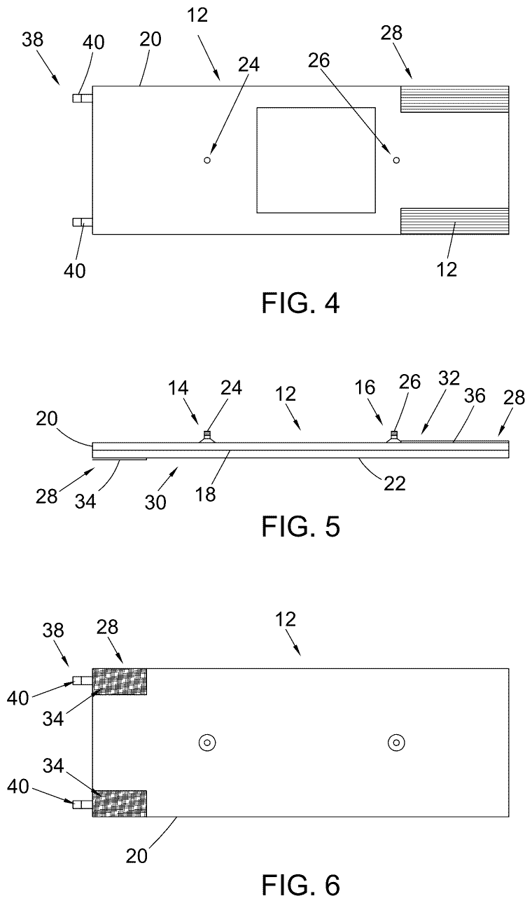

FIGS. 4, 5 and 6 of the accompanying drawings show top, side and bottom elevation views of the body 12 in the first configuration. As shown, in the illustrated apparatus 10 the body 12 is planar or substantially planar.

In the illustrated apparatus 10, the body 12 is constructed from a closed cell Neoprene material, the outer surface 18 of the body 12 being lined with a Nylon fabric liner 20 (shown in FIG. 1). However, it will be understood that the body 12 may alternatively or additionally be constructed from other suitable materials, for example but not exclusively an unlined Neoprene material, a rubber material, a latex material, a fluoroelastomer material such as Viton™.

The inner surface 22 of the body 12 is configured to sealingly engage at least part of the outer circumferential surface of the pipe connection C, so as to define the enclosed void V.

As described above, the apparatus 10 comprises an inlet arrangement 14 configured to facilitate ingress of the test fluid into the enclosed void V.

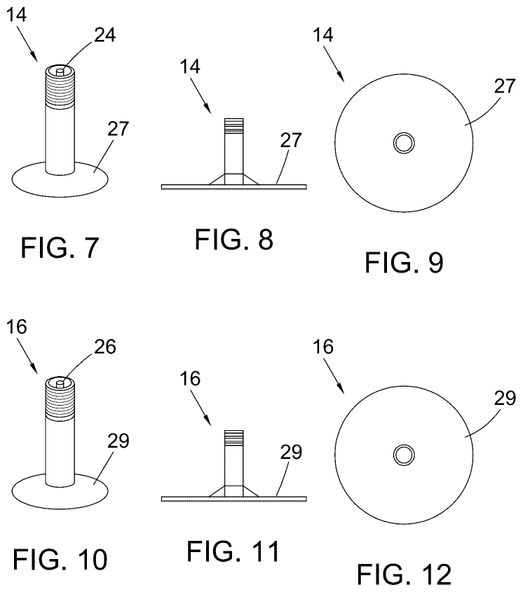

FIGS. 7, 8 and 9 of the accompanying drawings show the inlet arrangement 14. As shown, in the illustrated apparatus 10 the inlet arrangement 14 comprises an inlet valve 24. In the illustrated apparatus 10, the valve 24 takes the form of a Schrader valve. The inlet valve 24 is configured and/or oriented to permit ingress of the test fluid into the enclosed void V and restrict or prevent exhaust of the test fluid through the inlet valve 24.

FIGS. 10, 11 and 12 of the accompanying drawings show the outlet arrangement 16. As shown, in the illustrated apparatus 10 the outlet arrangement 16 comprises an outlet valve 26. In the illustrated apparatus 10, the outlet valve 26 takes the form of a Schrader valve. The outlet valve 26 is configured and/or oriented to permit exhaust of the test fluid together with air and/or any gas emitted from the pipe connection C and restrict fluid passage into the enclosed void V.

In the illustrated apparatus 10, the inlet arrangement 14 and outlet arrangement 16 are installed by cutting holes in the material of the body 12. The holes are heat treated to provide additional strength. The valves 24, 26 are respectively provided with a skirt 27, 29 of closed-cell Neoprene material of a different grade to the body 12 placed through the holes and glued onto the body 12 using a glue.

As shown most clearly in FIG. 3, the inlet arrangement 14 and the outlet arrangement 16 are spaced on the body 12 so that when the body 12 is disposed on the pipe connection C the inlet arrangement 14 and the outlet arrangement 16 define a separation angle. In the illustrated apparatus 10, the separation angle is 180 degrees. However, it will be understood that the apparatus 10 may be configured to provide any appropriate separation angle, for example but not exclusively in the range of 120 degrees to 180 degrees.

As described above, the body 10 takes the form of a cuff, wrap or band and is reconfigurable between a first configuration and a second configuration, the body 12 in the second configuration defining the enclosure around the pipe connection C.

The apparatus 10 comprises a securement arrangement, generally denoted 28. The securement arrangement 28 is configured to secure a first end portion 30 of the body 12 to a second end portion 32 of the body 12, so as to retain the body 12 on the pipe connection C.

The securement arrangement 28 is releasable, in the illustrated apparatus 10 the securement arrangement 28 comprising or taking the form of hook and loop fastener arrangement. As shown in FIGS. 4, 5 and 6 of the accompanying drawings, a hook side 34 of the hook and securement arrangement is disposed on the first end portion 30 of the body 12 while a loop side 36 of the hook and loop fastener arrangement is disposed on the second end portion 32 of the body 12. However, it will be understood that the hook side of the hook and loop fastener arrangement may alternatively or additionally be disposed on the second end portion 32 of the body 12 and the loop side of the hook and loop fastener arrangement may alternatively or additionally be disposed on the first end portion 30 of the body 12.

As shown in FIGS. 4 and 6 of the accompanying drawings, the apparatus 10 further comprises a strap arrangement, generally denoted 38.

In use, the strap arrangement 38 facilitates handling of the body 12 and/or to facilitate release of the securement arrangement 28.

In the illustrated apparatus 10, the strap arrangement 38 comprises two straps 40. However, it will be understood that the strap arrangement 38 may comprise one strap 40 or more than two straps 40.

The apparatus 10 comprises a pressurised fluid supply 42. The pressurised test fluid supply 42 is configured to supply the test fluid to the inlet arrangement 14.

As shown most clearly in FIG. 13, the pressurised test fluid supply 42 comprises a compressed gas cylinder 44, more particularly a compressed air cylinder. The pressurised test fluid supply 42 further comprises a pressure regulator 46 (also shown in FIG. 13) which in the illustrated apparatus 10 takes the form of a 2-stage regulator.

The apparatus 10 further comprises a fluid communication arrangement, generally denoted 48, for supplying the test fluid to the inlet arrangement 14. The fluid communication arrangement 48 comprises a fluid line 50, which in the illustrated apparatus 10 takes the form of a hose and a connector 52 for connecting the fluid line 50, for example hose, to the inlet arrangement 14. In the illustrated apparatus 10, the connector 52 takes the form of a clip-on connector. However, it will be understood that other suitable connectors may be utilised.

As described above, the apparatus 10 forms part of a system 1000 for detecting and/or quantifying gas emissions from a pipe connection C.

FIGS. 13 and 14 of the accompanying drawings show the system 1000 for detecting and/or quantifying gas emissions from a pipe connection C comprising the apparatus 10. FIG. 13 shows a diagrammatic view of the system 1000 while FIG. 14 shows the system 1000 in use.

As shown in FIGS. 13 and 14, in addition to the apparatus 10 the system 1000 further comprises a gas analyser 1002.

In the illustrated system 1000, the gas analyser 1002 comprises or takes the form of a portable gas analyser.

As shown in FIGS. 13 and 14, the system 1000 comprises a fluid communication arrangement, generally denoted 1004, for coupling the apparatus 10 to the gas analyser 1002. In the illustrated system 1000, the fluid communication arrangement 1004 comprises a fluid line 1006, which in the illustrated apparatus system 1000 takes the form of a hose, and a connector 1008 for connecting the gas analyser 1002 to the outlet arrangement 16 of the apparatus 10. In the illustrated system 1000, the connector 1008 takes the form of a clip-on connector. However, it will be understood that other suitable connectors may be utilised.

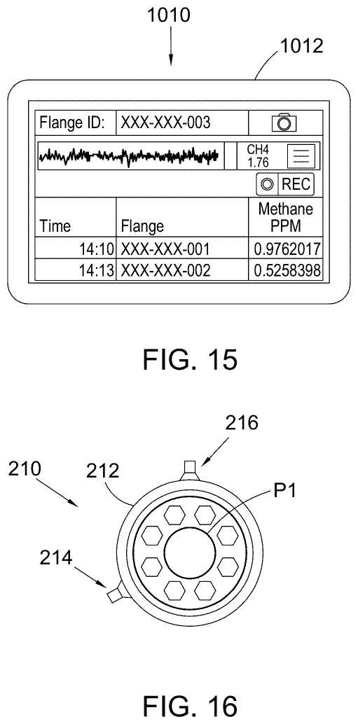

As shown in FIGS. 13 and 14, and referring now also to FIG. 15 of the accompanying drawings, the system 1000 further comprises a human interface, generally denoted 1010. In the illustrated system 1000, the human interface 1010 comprises a mobile tablet device 1012.

It will be understood that various modifications may be made without departing from the scope of the invention as defined in the claims.

For example, FIG. 16 of the accompanying drawings shows an alternative apparatus 210 having an alternative inlet arrangement 214 to that of the apparatus 10 shown in FIG. 1.

As in the apparatus 10, the inlet arrangement 214 and the outlet arrangement 216 of the apparatus 210 are spaced on the body 212 so that when the body 212 is disposed on the pipe connection C the inlet arrangement 214 and the outlet arrangement 216 define a separation angle. In the illustrated apparatus 210, the separation angle is 120 degrees. However, it will be understood that the apparatus 210 may be configured to provide any appropriate separation angle.

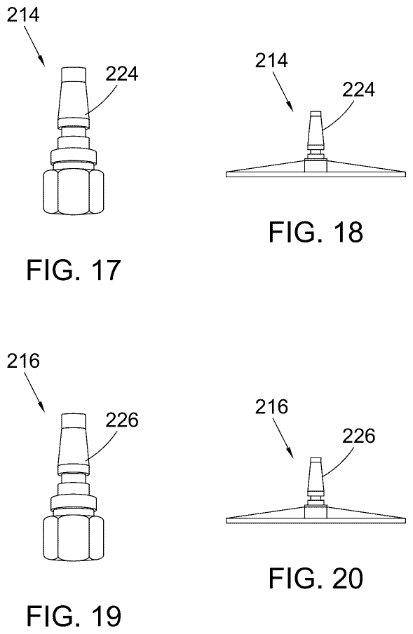

FIGS. 17 and 18 of the accompanying drawings show an alternative inlet arrangement 214 to the inlet arrangement 14 shown in FIGS. 7, 8 and 9.

As shown in FIGS. 17 and 18, the inlet arrangement 214 comprises a coupling adapter 224. In the illustrated inlet arrangement 214, the coupling adapter 224 takes the form of a Schrader coupling adapter.

FIGS. 19 and 20 of the accompanying drawings show an alternative outlet arrangement 216 to the outlet arrangement 16 shown in FIGS. 10, 11 and 12.

As shown in FIGS. 19 and 20, the outlet arrangement 216 comprises a coupling adapter 226 (a coupling adapter not having a valve). In the illustrated outlet arrangement 216, the coupling adapter 226 takes the form of a Schrader coupling adapter.

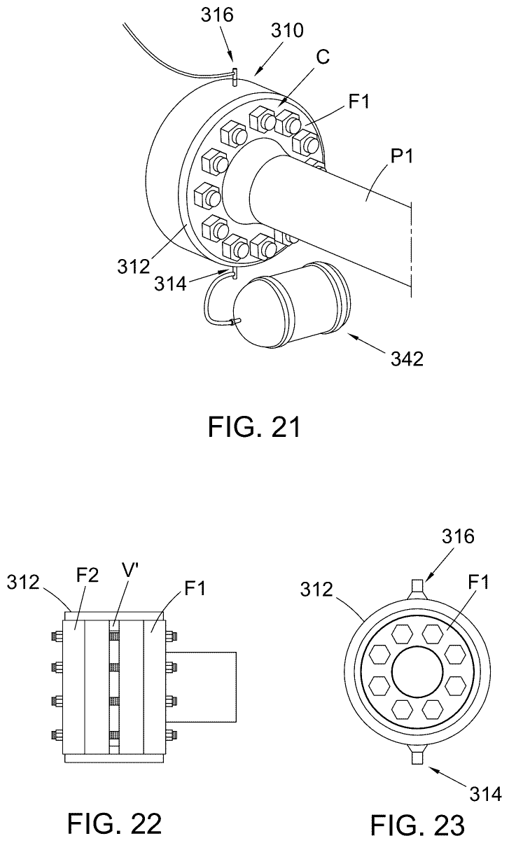

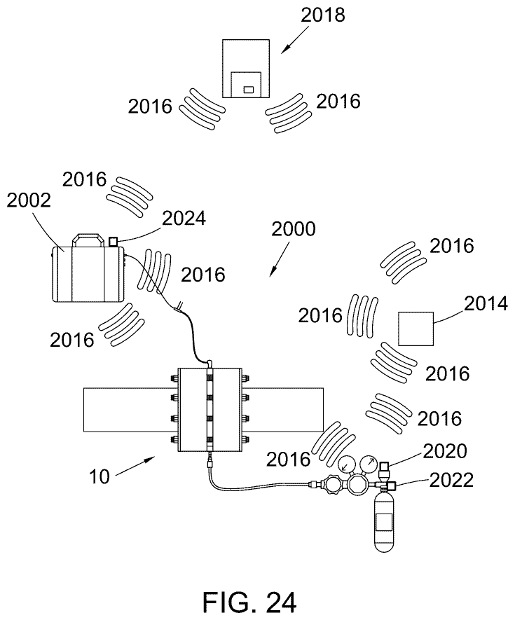

FIGS. 21, 22 and 23 of the accompanying drawings show a further alternative apparatus 310 for use in a system for detecting and/or quantifying gas emissions from a pipe connection C.

As shown, the apparatus 310 comprises a body 312 configured for location on and around the circumferential surface of the pipe connection C, which as shown takes the form of a blind flange connection having flange F1 on pipe P1 and flange cap F2.

The body 312 is configured to form an enclosure around a portion of the pipe connection C when located thereon, so as to define an enclosed void V′ between the body 312 and the outer circumferential surface of the pipe connection C.

The apparatus 310 further comprises an inlet arrangement, generally denoted 314, and an outlet arrangement, generally denoted 316. The inlet arrangement 314 is configured to facilitate ingress of a test fluid into the enclosed void V′. The outlet arrangement 316 is configured to facilitate exhaust of the test fluid together with air and/or any gas emitted from the pipe connection C from the enclosed void V′.

As shown in FIG. 21, the apparatus 310 comprises a pressurised fluid supply 342. The pressurised test fluid supply 342 is configured to supply the test fluid to the inlet arrangement 314.

Whereas in the apparatus 10, the body 12 is reconfigurable from a first, planar or substantially planer, configuration to a second, annular, configuration, in the apparatus 310 the body 312 is locatable on the pipe connection C in a first, annular, configuration, the body 312 in the first configuration forming the enclosed void V′. For example, the body 312 is configured, e.g. sized and/or annularly shaped, so that when located on the pipe connection C the body 312 forms the enclosed void V′.

FIG. 24 of the accompanying drawings shows an alternative system 2000 for detecting and/or quantifying gas emissions from a pipe connection C to that shown in FIGS. 13 and 14.

As shown in FIG. 24, the system 2000 comprises a controller 2014 and a communication arrangement, represented by 2016, to facilitate remote operation of the system 2000.

As shown, the system 2000 comprises a transceiver 2020 forming part of, coupled to or operatively associated with the apparatus 10. In the illustrated system 2000, the controller 2014 communicates wirelessly with the transceiver 2020 via the communication arrangement 2016 to control operation of an actuator 2022 of the apparatus 10. The transceiver 2020 communicates with the controller 2014, the remote location 2018 and/or the analyser 2002 via the communication arrangement 2016, for example to provide monitoring and/or status feedback regarding the apparatus 10.

The system 2000 further comprises a transceiver 2024 forming part of, coupled to or operatively associated with the gas analyser 2002. In the illustrated system 2000, the controller 2014 may communicate wirelessly with the transceiver 2024 via the communication arrangement 2016 to control operation of a gas analyser 2002 or the gas analyser 2002 may be independently operable, for example by onboard software. The transceiver 2024 may communicate with the controller 2014, the remote location 2018 and/or the apparatus 10 via the communication arrangement 2016, for example to provide monitoring and/or status feedback regarding the apparatus 10.

As shown, the controller 2014 also communicates with the remote location 2018, and vice-versa, via the communication arrangement 2016.

1. An apparatus for use in a system for detecting and/or quantifying gas emissions from a pipe connection, the apparatus comprising:
a body configured or configurable for location on and around the pipe connection,
wherein the body is configured to form an enclosure around a portion of the pipe connection when located thereon so as to define an enclosed void between the body and the portion of the pipe connection;
an inlet arrangement configured to facilitate ingress of a test fluid into the enclosed void; and
an outlet arrangement configured to facilitate exhaust of the test fluid together with air and/or any gas emitted from the pipe connection from the enclosed void.

2. The apparatus of claim 1, wherein the body comprises or takes the form of a cuff, a wrap or a band.

3. The apparatus of claim 1, wherein the body is configurable in a first configuration in which the body is planar, substantially planar or part-annular,
and wherein the body is reconfigurable into a second configuration in which the body is annular, the body in the second configuration forming the enclosed void.

4. The apparatus of claim 1, wherein the body is configurable in a first configuration in which the body is annular, the body in the first configuration forming the enclosed void.

5. The apparatus of claim 1, wherein the body is at least partially constructed from a material which prevents, substantially prevents or restricts passage of the air and/or the gas emitted from the pipe connection through the body.

6. The apparatus of claim 1, wherein the body is at least partially constructed from a polymeric material.

7. The apparatus of claim 6, wherein the body is at least partially constructed from an elastomeric material.

8. The apparatus of claim 7, wherein the body is at least partially constructed from polychloroprene.

9. The apparatus of claim 8, wherein the body is at least partially constructed from closed cell polychloroprene.

10. The apparatus of claim 1, wherein the inlet arrangement comprises or takes the form of an inlet valve.

11. The apparatus of claim 1, wherein the inlet arrangement comprises or takes the form of a coupling adapter.

12. The apparatus of claim 1, wherein the outlet arrangement comprises or takes the form of an outlet valve.

13. The apparatus of claim 1, wherein the outlet arrangement comprises or takes the form of a coupling adapter.

14. The apparatus of claim 1, wherein the inlet arrangement and the outlet arrangement are spaced on the body.

15. The apparatus of claim 14, wherein the inlet arrangement and the outlet arrangement are spaced on the body, such that when located on the pipe connection the inlet arrangement and the outlet arrangement define a separation angle.

16. The apparatus of claim 1, comprising a securement arrangement configured to retain the body on the pipe connection.

17. The apparatus of claim 16, wherein the securement arrangement comprises or takes the form of a releasable securement arrangement, e.g. a hook and loop fastener arrangement.

18. The apparatus of claim 1, wherein the apparatus comprises, is coupled to or operatively associated with a pressurised test fluid supply.

19. The apparatus of claim 18, wherein the pressurised test fluid supply comprises a compressed air cylinder having ambient air of known composition of the gas being detected and/or quantified.

20. A system for detecting and/or quantifying gas emissions from a pipe connection, the system comprising:
the apparatus of claim 1; and
a gas analyser.

21. The system of claim 20, wherein the gas analyser comprises or takes the form of a portable gas analyser.

22. The system of claim 20, comprising a wireless or wired communication arrangement configured to communicate a quantitative base line measurement and/or subsequent quantitative measurement(s) of gas emissions in the enclosed void to one or more remote location.

23. The system of claim 20, wherein the system comprises, is coupled to or operatively associated with a processing system configured or operable to control the apparatus and/or the system.

24. A method of detecting and/or quantifying gas emissions from a pipe connection, using the system of claim 20.

25. The method of claim 24, wherein the method comprises:
locating the apparatus on the pipe connection to be tested; and
flowing the test fluid into the enclosed void through the inlet arrangement, where it co-mingles with the air and any gas emitted from the pipe connection already present in the enclosed void, a co-mingled product formed by the test fluid together with the air and any gas already present in the enclosed void flowing out through the outlet arrangement until a measured gas composition reading in the enclosed void has stabilised.

26. The method of claim 25, further comprising carrying out one or more quantitative measurements in the enclosed void using the gas analyser.
